(19) United States
(12) Patent Application Publication
(10) Pub. No.: US 2024/0425103 A1
(43) Pub. Date: Dec. 26, 2024

(54) STEERING APPARATUS HAVING A STEERING SHAFT AND HAVING AN END STOP DEVICE FOR LIMITING A STEERING ANGLE OF ROTATION, AND STEER-BY-WIRE STEERING SYSTEM HAVING SUCH A STEERING DEVICE

(71) Applicant: ZF AUTOMOTIVE GERMANY GMBH, Alfdorf (DE)

(72) Inventors: Richard Büker, Willich (DE); Marcin Mojzesz, SWINNA (PL); Ram Prasad Musunuru, Neuss (DE)

(21) Appl. No.: 18/753,335

(22) Filed: Jun. 25, 2024

(30) Foreign Application Priority Data
Jun. 26, 2023 (DE) 10 2023 206 002.7

(51) Int. Cl. B62D 5/00; B62D 1/16

(52) U.S. Cl. CPC B62D 5/001; B62D 1/16

(57) ABSTRACT

The invention relates to a steering apparatus (1) having a steering shaft (5) and having an end stop device (10) for limiting a steering angle of rotation, the end stop device (10) having a first blocking element (11), and the first blocking element (11) being movable in an axial direction of the longitudinal center axis (6) of the steering shaft (5) in order to limit the steering angle of rotation, the first blocking element (11) cooperating with a positionally fixed further blocking element (12) in order to stop rotation of the steering shaft (5) about the longitudinal center axis (6) and with regard to two directions of rotation (7, 8) of the steering shaft (5) that are directed in opposite directions to one another. In order for it to be possible to reliably pick up and transmit high forces and/or torques in a stop position of the steering apparatus (1), the steering apparatus (1) is designed such that the movement of the first blocking element (11) is guided by means of an entrainment device (16), the entrainment device (16) being connected to the steering shaft (5) in a positionally fixed manner in order to rotate conjointly with the steering shaft (5).

### TECHNICAL FIELD

The invention relates to a steering apparatus having a steering shaft and having an end stop device for limiting a steering angle of rotation, the end stop device having a first blocking element, and the first blocking element being movable in an axial direction of the longitudinal center axis of the steering shaft in order to limit the steering angle of rotation, the first blocking element cooperating with a positionally fixed further blocking element in order to stop rotation of the steering shaft about the longitudinal center axis and with regard to two directions of rotation of the steering shaft that are directed in opposite directions to one another. The invention also relates to a steer-by-wire steering system having such a steering device.

### BACKGROUND

A steering apparatus of this type and such a steer-by-wire steering system are known from DE 10 2021 206 069 A1.

In particular in a steer-by-wire steering system there is no mechanical connection between a steering handle such as a steering wheel and a steering gear. Therefore, steering commands are transmitted by means of a control unit to an electric motor which moves a steering rack via the steering gear in order to steer the wheels. In this case, the steering rack can set a steering angle of rotation at the wheels by means of track rods. Preferably, the steering apparatus has a feedback motor which simulates steering forces in order to provide the driver with feedback from the acting steering forces.

In a conventional steering system having a mechanical connection between the steering wheel and the steering rack, the steering angle of rotation of a steering wheel limited on account of the existing mechanical system. By contrast, on account of the lack of a mechanical connection between the steering apparatus and the steering gear in a steer-by-wire steering system, it would be possible to rotate the steering wheel endlessly in one direction of rotation. However, this gives rise to the risk of overloading or damaging constituent parts of the steering apparatus. Moreover, the driver requires feedback about the maximally achievable steering angle of rotation at the wheels.

### SUMMARY

Therefore, the steering apparatus mentioned at the beginning comprises an end stop device for limiting the steering angle of rotation. However, in a stop position, high forces and/or torques may act. On account of the limited installation space, however, it is not possible to form stop elements or stop surfaces that are as large as desired. Therefore, there is often the risk of the steering apparatus being overloaded and thus damaged. In addition, it is often necessary to use undesirably high-grade and thus expensive materials to produce a stop solution.

The problem underlying the invention is that of developing a steering apparatus and/or a steer-by-wire steering system of the type mentioned at the beginning in such a way that, in a stop position of the steering apparatus, high forces and/or torques can be reliably picked up and transmitted. Preferably, a space-saving embodiment is made available. In particular, an alternative embodiment is intended to be provided.

The problem underlying the invention is solved by a steering apparatus as claimed in claim 1 and by means of a steer-by-wire steering system as claimed in claim 15. Preferred developments of the invention can be found in the dependent claims and in the following description.

Thus, the invention relates to a steering apparatus. The steering apparatus may have a steering wheel. In this case, the term steering wheel is synonymous for a steering handle of any shape and/or design. The steering apparatus has a steering shaft. In particular, the steering shaft is rotatable or mounted so as to be rotatable about its longitudinal center axis. In this case, the steering shaft is rotatable about the longitudinal center axis in two directions of rotation that are directed in opposite directions to one another. The steering wheel may be arranged at one end of the steering shaft.

Furthermore, the steering apparatus has an end stop device. By means of the end stop device, a steering angle of rotation of the steering apparatus and thus the rotation of the steering shaft about its longitudinal center axis in the two directions of rotation is limited. The steering apparatus may have a feedback motor. In this case, the steering shaft may provide a controllable torque resistance and/or be set into rotation about the longitudinal center axis of the shaft by means of the feedback motor, in particular with a gear being interconnected. As a result, the driver of a vehicle or motor vehicle having such a steering apparatus can be provided with feedback from the steering forces acting at the wheels. In particular, the feedback motor is in the form of an electric motor. The feedback motor may be arranged at an opposite end of the steering shaft from the steering wheel.

The end stop device has a first blocking element. In this case, the first blocking element is movable in an axial direction of the longitudinal center axis of the steering shaft in order to limit the steering angle of rotation. In order to stop rotation of the steering shaft about the longitudinal center axis, the first blocking element cooperates with a further blocking element arranged in a fixed position. In particular, the first blocking element and the further blocking element form a blocking device.

The movement of the first blocking element is guided by means of an entrainment device, the entrainment device being connected to the steering shaft in a positionally fixed manner in order to rotate conjointly with the steering shaft.

In this case, it is advantageous that, on account of the positionally fixed attachment of the entrainment device to the steering shaft or to a portion of the steering shaft, space-saving entrainment and/or guidance of the first blocking element is allowed. In particular, alternative embodiments are allowed.

Preferably, the first blocking element makes direct contact with the entrainment device. The entrainment device may be formed in one part or a plurality of parts. In particular, on account of the positionally fixed attachment of the entrainment device to the steering shaft or to a portion of the steering shaft in combination with the direct contact between the entrainment device and the first blocking element, space-saving entrainment and/or guidance of the first blocking element is able to be brought about.

According to a further embodiment, the end stop device has a rotational device. In this case, the entrainment device is connected to the rotational device. The rotational device has at least one rotational element which is rotatable about the longitudinal center axis of the steering shaft and/or conjointly with the steering shaft. In particular, the rotational device has a plurality of annular rotational elements which are arranged in succession in the axial direction of the longitudinal center axis. In this case, each rotational element has at least one stop portion for cooperating with the respectively adjacent rotational element. In particular, a maximum steering angle of rotation is defined by means of the rotational device. For example, starting from a zero position or dead-center position, a maximum steering angle of rotation of ±660° may be defined. The stop portion may be in the form of a two-sided or double-sided protrusion. In particular, the stop portion extends parallel to the longitudinal center axis of the steering shaft.

On account of rotation of the steering shaft, the at least one rotational element or the plurality of rotational elements may be set into rotation. In particular in the case of continuous rotation in the same direction of rotation, it is possible, in the case of a plurality of rotational elements, for the stop portions of directly adjacent rotational elements to successively butt against one another and to be entrained in rotation. A maximum steering angle of rotation in both directions of rotation of the steering shaft may be defined or set via the number of rotational elements and/or the position of the stop portions.

Preferably, the rotational device has a rotation stopper which limits rotation of the at least one rotational element both in the first direction of rotation and in the second direction of rotation. In particular the rotation stopper is held in a rotationally fixed manner and/or formed in an annular manner. The rotation stopper may be arranged in a rotationally fixed manner in a tubular steering column housing. Preferably, the rotation stopper is mounted so as to be displaceable in the axial direction with respect to the longitudinal center axis. Thus, the rotation stopper may be moved linearly, in particular conjointly with the first blocking element, in the axial direction of the steering shaft.

According to one development, a transmission element is arranged between the first blocking element and the rotational device and/or the at least one rotational element. In this case, the transmission element has a first end portion and a second end portion at the opposite end from the first end portion. In particular the at least one rotational element is arranged at the first end portion. Preferably the first end portion is a constituent part of the rotational device.

The first end portion may have a further stop which is designed to cooperate with the stop portion of the at least one rotational element. Thus, on account of rotation of the transmission element about the longitudinal center axis of the steering shaft, the further stop of the transmission element can butt against the stop portion of the at least one rotational element.

Upon rotation of the steering shaft in one of the two directions of rotation, first of all one side of the further stop of the transmission element thus butts against the stop portion of the at least one rotational element or of the directly adjacent rotational element in the case of a plurality of rotational elements. In the case of a plurality of rotational elements and continued rotation in the same direction of rotation, the stop portions of directly adjacent rotational elements thus butt successively against one another. Finally, the stop portion of the rotational element directly adjacent to the rotation stopper butts against a stop of the rotation stopper. This blocks further rotation of the rotational element and/or of the transmission element upon continued rotation in the same direction of rotation, with the result that ultimately all of the rotational elements are blocked.

The first end portion may have a tubular receptacle for the arrangement of the at least one rotational element. In this case, the at least one rotational element is mounted so as to be rotatable about the longitudinal center axis of the steering shaft and on the tubular receptacle. The tubular receptacle may be formed in one part or a plurality of parts. For example, the tubular receptacle is formed by means of a plurality of flexible tongues that are pretensioned radially outwardly with respect to the longitudinal center axis of the steering shaft. In this case, the at least one rotational element or the plurality of rotational elements is/are fitted on the flexible tongues. The plurality of flexible tongues may be arranged regularly in the circumferential direction about the first end portion. Preferably, the annular rotation stopper is likewise arranged on the tubular receptacle. In particular the free ends of the flexible tongues each have a detent, the flexible tongues engaging through the at least one rotational element and the rotation stopper and the detents engaging behind the rotation stopper. As a result, the at least one rotational element, the rotation stopper and the transmission element are held together as seen in the axial direction of the longitudinal center axis of the steering shaft. This results in a compact cohesive construction.

In particular the first end portion has a smaller outside diameter than the second end portion. Preferably, the outside diameter of the first end portion is adapted to the inside diameter of the at least one rotational element and/or of the rotation stopper. As a result, the outer circumference of the first end portion can bear against the inner circumference of the at least one rotational element and/or of the rotation stopper. In particular the outside diameter of the second end portion corresponds to the outside diameter of the at least one rotational element and/or of the rotation stopper.

The first blocking element is fastened to the second end portion. The outside diameter of the second end portion may correspond to the outside diameter of the first blocking element. In particular, on account of the fixed connection between the second end portion and the first blocking element, the rotation of the steering shaft is transmissible to the transmission element via the first blocking element and to the rotational device via the transmission element.

The second end portion may have a plurality of fastening tabs which, for the fixed connection to the first blocking element, are received form-fittingly in fastening receptacles, formed in a manner corresponding to the fastening tabs, in an outer side of the first blocking element. The plurality of fastening tabs may be arranged in a manner distributed regularly in the circumferential direction about the second end portion. In particular the fastening tabs each have, on their inner side, a first latching element which cooperates form-fittingly with a corresponding second latching element of the fastening receptacle. For example, the first latching element is in the form of a protrusion extending radially with respect to the longitudinal center axis of the steering shaft and the second latching element is in the form of an opening of corresponding shape.

According to a further embodiment, a spring element, in particular a compression spring, is arranged between the entrainment device and the transmission element. In this case, the spring element is supported on the transmission element on one side and directly on the entrainment device or a spring receiving element connected to the entrainment device on the other side. In particular the spring element counteracts cooperation of the first blocking element with the further blocking element. The entrainment device may be formed in one part or a plurality of parts. Preferably the entrainment device is formed in one piece and/or in a sleeve-like manner. Given such a one-part or one-piece design of the entrainment device, a spring receptacle for providing support for the spring element may be an integral and/or one-piece constituent part of the entrainment device itself. Alternatively, in addition to the entrainment device, the spring receiving element, formed as a separate part, for supporting the spring element may be connected to the entrainment device. In particular the spring element is connected at least in a rotationally fixed manner to the entrainment device. Alternatively, the spring element may be mounted so as not to rotate. For example, the spring element may be fitted on an axial end of the entrainment device in the axial direction with respect to the longitudinal center axis of the steering shaft.

According to one development, the first blocking element, the transmission element and the rotational element form a structural unit. This structural unit, on account of cooperating with the entrainment device, is rotatable about the longitudinal center axis of the steering shaft and/or displaceable in the axial direction of the longitudinal center axis of the steering shaft. Preferably the structural unit is displaceable in the axial direction of the longitudinal center axis of the steering shaft only as a whole. The connection between the first blocking element, the transmission element and the rotational device is designed such that an axial relative movement between the first blocking element, the transmission element and the rotational device is blocked. In particular the end stop device and/or the structural unit is/are formed in a tubular manner. As a result, the steering shaft can extend through the entire end stop device and/or the structural unit. Preferably the end stop device is arranged between the steering shaft and an inner side of a tubular steering column housing.

According to a further embodiment, at least one portion of the entrainment device or of the spring receiving element, for the one part, and at least one portion of the transmission element, for the other part, form a return device for reversing cooperation of the first blocking element and the further blocking element. In particular, by means of the return device, a defect or failure of the spring element is able to be compensated. The spring element counteracts cooperation of the first blocking element with the further blocking element. As a result, when the steering shaft is turned back from an end position with a maximum steering angle of rotation, the first blocking element is moved in the axial direction with respect to the longitudinal center axis of the steering shaft and out of the further blocking element. In the event of a defect or failure of the spring element, the return device ensures that, when the steering shaft is turned back from an end position with a maximum steering angle of rotation, the first blocking element is moved in the axial direction with respect to the longitudinal center axis of the steering shaft and out of the further blocking element.

In particular the transmission element has at least one first inclined surface and at least one second inclined surface, the entrainment device or the spring receiving element having a first mating inclined surface for cooperating with the first inclined surface and a second mating inclined surface for cooperating with the second inclined surface. Preferably the two inclined surfaces and the two mating inclined surfaces are oriented obliquely with respect to the axial extension of the longitudinal center axis. The two inclined surfaces and the two mating inclined surfaces may each be oriented in a V-shape with respect to one another. The inclined surfaces and mating inclined surfaces may be designed in such a way that they do not touch in the case of an intact spring element. As a result, friction that is unnecessary in normal use is avoided. It is only in the event of a defective or failed spring element that the inclined surface and the mating inclined surface come into contact. The entrainment device or the spring receiving element may have a triangular protrusion which has the two inclined surfaces. The transmission element may have a V-shaped recess which has the two mating inclined surfaces and in which the protrusion is guided.

Preferably the steering shaft extends through the end stop device, a first end of the steering shaft being designed for the arrangement of a steering handle. In particular the end stop device is arranged within an, in particular telescopic, steering column. Preferably the tubular end stop device is arranged between the steering shaft and a tubular steering column housing. In particular the further blocking element is fastened to the inner side of the steering column housing in a fixed position. Preferably the rotation stopper is arranged on the inner side of the steering column housing so as to be rotationally fixed and at the same time displaceable axially in the direction of the longitudinal center axis of the steering shaft.

According to a further embodiment, the entrainment device has, distributed about its outer circumference, a plurality of guide ribs, the guide ribs extending parallel to the longitudinal center axis of the steering shaft. The guide ribs may extend along the entire length of the entrainment device or only along a part of the entrainment device. The guide ribs cooperate with a guide slot in the first blocking element. In particular the guide slot is formed on an inner side of the sleeve-like first blocking element. Thus, the entrainment device has a smaller outside diameter than the first blocking element. In particular the entrainment device and/or the spring receiving element is/are arranged and/or received partially within the first blocking element and partially with the transmission element.

Preferably the guide ribs each have an end surface and/or a sliding surface on an end facing the further blocking element. In this case, the end surface extends at right angles to the longitudinal center axis of the steering shaft. In particular the sliding surface extends, from the end surface, obliquely with respect to the axial extension of the longitudinal center axis of the steering shaft. Preferably the entrainment device has a plurality of pairs of guide ribs, the two guide ribs of a respective pair being mirror-symmetric to one another. In this case, the sliding surfaces of the two guide ribs of a respective pair may face one another.

Each guide slot in the first blocking element may have a mating end surface located opposite the end surface of the guide rib. At least one free gap may be formed between the end surface and the mating end surface. Furthermore, the guide slot in the first blocking element may have a mating sliding surface for cooperating with the sliding surface of the guide rib. In a manner corresponding to the end surface and/or the sliding surface, the mating end surface extends in this case at right angles to the longitudinal center axis of the steering shaft, and/or the mating sliding surface, in particular starting from the mating end surface, extends obliquely with respect to the axial extension of the longitudinal center axis of the steering shaft. In particular the sliding surface of the guide rib is shorter than the mating sliding surface of the first blocking element. As a result, the sliding surface and the mating sliding surface can slide on one another depending on the length of the two surfaces. This allows the axial movement of the first blocking element in order to cooperate with the further blocking element. Preferably a plurality of pairs of mating sliding surfaces are formed in the guide slot of the first blocking element, the two mating sliding faces of a pair being oriented in a V-shape or V-shaped manner with respect to one another.

According to one development, the guide ribs of the entrainment device each have an entrainment surface on one side of the guide rib. In particular in the case of a pair of guide ribs, the entrainment surfaces of the two guide ribs face one another. Each first blocking element has a mating entrainment surface for cooperating with the entrainment surface. In particular the entrainment surface and the mating entrainment surface are oriented parallel to the longitudinal center axis of the steering shaft. Preferably the mating sliding surface transitions into the mating entrainment surface. Accordingly, the mating entrainment surface may be formed in the region of an end of the mating sliding surface that faces away from the mating end surface.

According to a further embodiment, in a rotary mode of the rotational device, when the steering shaft is rotated about the longitudinal center axis by means of the entrainment device, the first blocking element is rotatable conjointly with the steering shaft in one of the two directions of rotation about the longitudinal center axis of the steering shaft. In particular the rotational device is in the rotary mode when the current steering angle of rotation lies between the two maximum steering angles of rotation. In this case, starting from a zero position or dead-center position, a maximum positive steering angle of rotation is associated with a first direction of rotation and a maximum negative steering angle of rotation is associated with a second direction of rotation directed in the opposite direction to the first direction of rotation. Preferably, in the rotary mode of the rotational device, a sliding surface of the guide rib bears against a portion, facing the further blocking element, of a mating sliding surface of the first blocking element. In particular the portion of the mating sliding surface of the first blocking element that faces the further blocking element is pressed against the sliding surface of the respective guide rib on account of the action of the spring element. In particular, in the rotary mode, two sliding surfaces, facing away from one another, of two adjacent guide ribs bear against mating sliding surfaces of the first blocking element in a V shape or V-shaped manner or wedge-like manner.

According to one development, the rotational device, after passing from the rotary mode into a stop mode of the rotational device, is prevented from rotating further about the longitudinal center axis of the steering shaft. In this case, the first blocking element, in the stop mode of the rotational device, is movable by means of the entrainment device and, upon further rotation of the steering shaft in the same direction of rotation, only in the axial direction with respect to the longitudinal center axis. As a result, the first blocking element can engage in the further blocking element. In particular the axially directed movement of the first blocking element is brought about on account of a sliding movement of the mating sliding surface of the first blocking element on the sliding surface of the entrainment device. Alternatively, the axially directed movement of the first blocking element, rather than being brought about by means of the sliding movement, can be brought about by means of a screw drive.

The first blocking element may have a first toothed structure which faces the further blocking element. The further blocking element may have a second toothed structure for cooperating with the first toothed structure. Preferably, in the stop mode of the rotational device, teeth of the first toothed structure are oriented, in particular centrally, opposite tooth gaps of the second toothed structure. In a corresponding manner, in the stop mode of the rotational device, teeth of the second toothed structure are oriented, in particular centrally, opposite tooth gaps of the first toothed structure. The first toothed structure and the second toothed structure may be designed with mutually corresponding shapes.

Preferably the teeth of the first toothed structure and of the second toothed structure have different widths. In a corresponding manner, the tooth gaps of the first toothed structure and of the second toothed structure may have different widths. As a result, the teeth of the two toothed structures may continue not to be in contact with one another after the axial movement of the first blocking element and the engagement of the teeth in the respective opposite tooth gaps.

In particular at least one mating entrainment surface of the first blocking element, when a maximum axially extended position of the first blocking element is reached, butts against at least one entrainment surface of the entrainment device. Upon further rotation of the steering shaft in the same direction of rotation, the first blocking element may be rotatable conjointly with the entrainment device only about the longitudinal center axis of the steering shaft. In particular this rotating movement is limited by a clearance, arising in the circumferential direction, between the axially engaged teeth of the two toothed structures. Preferably at least one blocking surface of the first blocking element, when a maximum steering angle of rotation is reached, butts against at least one mating blocking surface of the further blocking element. In particular the blocking surface and the mating blocking surface are oriented parallel or obliquely with respect to the longitudinal center axis of the steering shaft.

A steer-by-wire steering system having a steering apparatus according to the invention is particularly advantageous. Preferably, the steer-by-wire steering system is developed as per the embodiments explained in conjunction with the steering apparatus according to the invention that is described herein.

### BRIEF DESCRIPTION OF THE DRAWINGS

The invention is explained in more detail in the following text with reference to the figures. Herein, identical reference signs refer to the same, similar or functionally identical components or elements. In the figures:

FIG. 1 shows a side view of a steering apparatus according to the invention,

FIG. 2 shows a partially transparent, perspective side view of the steering apparatus according to the invention according to FIG. 1,

FIG. 3 shows a perspective exploded view of an end stop device for the steering apparatus according to the invention according to FIGS. 1 and 2,

FIG. 4 shows a perspective side view of a part of the end stop device according to FIG. 3,

FIG. 5 shows a perspective side view of the end stop device according to FIG. 3 in a rotary mode of a rotational device,

FIG. 6 shows a detail of a perspective side view of the end stop device according to FIG. 3 in a stop mode of the rotational device,

FIG. 7 shows a perspective side view of the end stop device, in which a first blocking element is engaging in a further blocking element,

FIG. 8 shows a detail of a perspective cross section through the end stop device according to FIG. 7, and

FIG. 9 shows a perspective side view of the end stop device in a stop end position associated with a maximum steering angle of rotation.

### DESCRIPTION

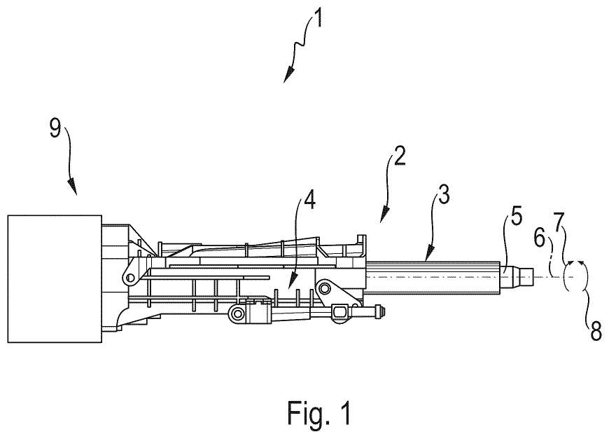

FIG. 1 shows a side view of a steering apparatus 1 according to the invention. The steering apparatus 1 is a constituent part of a steer-by-wire steering system that is not illustrated in more detail here. Here, the steering apparatus 1 is provided or designed for example for a motor vehicle. The steering apparatus 1 has a steering column 2. In this exemplary embodiment, the steering column 2 is telescopic and thus designed to have an adjustable length. To this end, the steering column 2 has, according to this example, a first tubular steering column housing 3 and a second tubular steering column housing 4. The first steering column housing 3 is received at least partially in a linearly displaceable manner in the second steering column housing 4. The first steering column housing 3 can be referred to as upper steering column and the second steering column housing as lower steering column.

Arranged within the steering column 2 and thus within the first steering column housing 3 and the second steering column housing 4 is a steering shaft 5. The steering shaft 5 is assigned a longitudinal center axis 6, wherein the steering shaft 5 is mounted so as to be rotatable about the longitudinal center axis 6. In this exemplary embodiment, a longitudinal center axis of the first steering column housing 3 additionally coincides with the longitudinal center axis 6.

In this exemplary embodiment, the steering shaft 5 is connected to a steering wheel that is not illustrated in more detail here. To this end, an end of the steering shaft 5 that is at the opposite end from the second steering column housing 4 extends out of the first steering column housing 3. The steering shaft 5 is rotatable, in particular by means of the steering wheel and/or starting from a dead-center position of the steering shaft 5, in two directions of rotation that are directed in opposite directions to one another about the longitudinal center axis 6. The two directions of rotation are indicated by means of the arrows 7, 8.

In this exemplary embodiment, the steering apparatus 1 has a feedback motor 9. The steering shaft 5 can be set in rotation about the longitudinal center axis 6 by means of the feedback motor 9 and provide a controllable torque resistance. As a result, the driver of a vehicle or motor vehicle having such a steering apparatus 1 can be provided with feedback from steering forces acting on wheels. In this exemplary embodiment, the feedback motor 9 is in the form of an electric motor. Furthermore, the feedback motor 9 is arranged at an end of the steering shaft 5 that is at the opposite end from the end intended for a steering wheel.

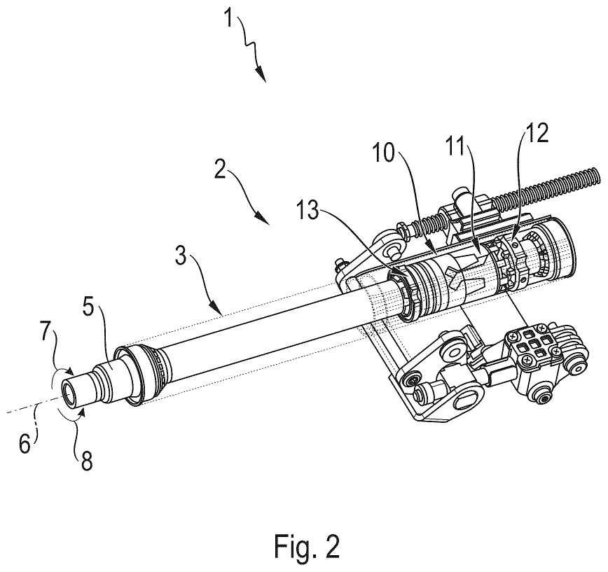

FIG. 2 shows a partially transparent, perspective side view of the steering apparatus 1 according to the invention according to FIG. 1. For the sake of greater clarity, constituent parts such as the second steering column housing 4 have been omitted here. The first steering column housing 3 is illustrated in a partially transparent manner here.

The steering apparatus 1 has an end stop device 10 for limiting a steering angle of rotation. Thus, the rotatability of the steering shaft 5 in the two directions of rotation directed in opposite directions to one another as per arrows 7, 8 is limited by means of the end stop device.

The steering shaft 5 extends through the end stop device 10. In this case, the end stop device 10 is arranged within the steering column 2, more specifically, in this exemplary embodiment, within the first steering column housing 3. With regard to its basic shape, the end stop device is tubular. Furthermore, the end stop device 10 is arranged between the steering shaft 5 and the likewise tubular first steering column housing 3.

Inter alia, the end stop device 10 has a first blocking element 11 and a further blocking element 12. In this case, the further blocking element 12 forms a first end of the end stop device 10. In addition, the further blocking element 12 is fastened in a fixed position to an inner side of the first steering column housing 3.

Furthermore, the end stop device 10 has a rotation stopper 13. The rotation stopper 13 forms a second end of the end stop device 10 that is at the opposite end from the first end or from the further blocking element 12. In this case, although the rotation stopper 13 is rotationally fixed, it is, at the same time, arranged on the inner side of the first steering column housing 3 so as to be axially displaceable in the direction of the longitudinal center axis 6 of the steering shaft 5.

The further structure and functionality of the end stop device 10 will be explained in more detail with reference to the following figures.

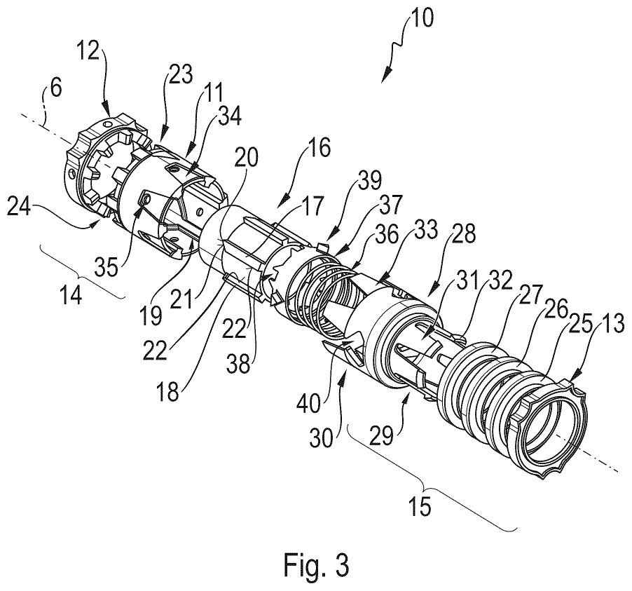

FIG. 3 shows a perspective exploded view of the end stop device 10 for the steering apparatus 1 according to the invention according to FIGS. 1 and 2. Further components of the steering apparatus 1 have been omitted for the sake of greater clarity.

The first blocking element 11 and the further blocking element 12 form a blocking device 14. A rotational device 15 is formed at an end of the end stop device 10 that is at the opposite end from the blocking device 14.

The end stop device 10 has an entrainment device 16. In the assembled state according to FIG. 2, the entrainment device 16 is connected to the steering shaft 5 in a positionally fixed manner in order to rotate conjointly with the steering shaft 5. In the assembled state according to FIG. 2, direct contact between the first blocking element 11 and the entrainment device 16 has been brought about. The entrainment device 16 is designed to guide the first blocking element 11.

Distributed about its outer circumference, the entrainment device 16 has a plurality of guide ribs 17, 18. For the sake of greater clarity, not all of the guide ribs 17, 18 have been provided with a reference sign. The guide ribs 17, 18, extend parallel to the longitudinal center axis 6. In this exemplary embodiment, the guide ribs 17, 18 extend only along a part or a partial length of the entrainment device 16.

The guide ribs 17, 18 are designed to cooperate with a guide slot 19 in the first blocking element 11. In this case, the guide slot 19 is formed on an inner side of the sleeve-like first blocking element 11. Accordingly, the entrainment device 16 has a smaller outside diameter than the first blocking element 11.

The guide ribs 17, 18 each have an end surface 20 and/or a sliding surface 21 on an end facing the further blocking element 12. In this case, the end surface 20 extends at right angles to the longitudinal center axis 6 and the sliding surface 21 extends, from the end surface 20, obliquely with respect to the axial extension of the longitudinal center axis 6. In an alternative embodiment, it is possible to dispense with the formation of the end surface 20. In this exemplary embodiment, in each case two guide ribs 17, 18 form a pair of guide ribs 17, 18. The two guide ribs 17, 18 of a respective pair are mirror-symmetric to one another. In this case, the sliding surfaces 21 of the two guide ribs 17, 18 of a respective pair face one another.

Furthermore, the guide ribs 17, 18 of the entrainment device 16 each have an entrainment surface 22 on one side of the respective guide rib 17, 18. In a respective pair of guide ribs 17, 18, the entrainment surfaces 22 of the two guide ribs 17, 18 face one another.

The first blocking element 11 has a first toothed structure 23 which faces the further blocking element 12. The further blocking element 12 has a second toothed structure 24 for cooperating with the first toothed structure 23. Thus, the second toothed structure 24 is designed to face the first blocking element 11.

In this exemplary embodiment, the rotational device 15 has a plurality of, in this case for example three, rotational elements 25, 26, 27. The rotational elements 25, 26, 27 are mounted so as to be rotatable about the longitudinal center axis 6. The rotational elements 25, 26, 27 are formed in an annular or in this case ring-like manner. Furthermore, the rotational elements 25, 26, 27 are arranged in succession in the axial direction of the longitudinal center axis 6.

By means of the rotation stopper 13, rotation of the rotational elements 25, 26, 27 is limited both in the first direction of rotation and in the second direction of rotation as per the arrows 7, 8 according to FIGS. 1 and 2. To this end, the rotation stopper 13, which is annular in this exemplary embodiment, is held in a rotationally fixed manner on the inner side of the first steering column housing 3 according to FIG. 2.

According to this exemplary embodiment, a transmission element 28 is arranged between the first blocking element 11 and the rotational device 15 or the rotational elements 25, 26, 27. The transmission element 28 has a first end portion 29 and a second end portion 30 at the opposite end from the first end portion 29. At the first end portion 29, the rotational elements 25, 26, 27 are arranged so as to be rotatable about the longitudinal center axis 6. In this exemplary embodiment, the first end portion 29 is a constituent part of the rotational device 15. To this end, the first end portion 29 forms a tubular receptacle for the arrangement of the rotational elements 25, 26, 27. Thus, the rotational elements 25, 26, 27 are mounted on the tubular receptacle, formed by means of the first end portion 29, so as to be rotatable about the longitudinal center axis 6. In this exemplary embodiment, the first end portion 29, or the tubular receptacle, is formed in a plurality of parts. In this case, the first end portion 29, or the tubular receptacle, is formed by means of a plurality of flexible tongues 31 that extend axially with respect to the longitudinal center axis 6 and are pretensioned radially outwardly with respect to the longitudinal center axis 6. For the sake of greater clarity, not all of the flexible tongues 31 have been provided with a reference sign. In this case, the plurality of rotational elements 25, 26, 27 are fitted on the flexible tongues 31 in the assembled state according to FIG. 2.

In the assembled state according to FIG. 2, the annular rotation stopper 13 is likewise arranged at the first end portion 29 or on the tubular receptacle. In this case, the rotation stopper 13 is mounted with regard to the first end portion 29 so as to be rotatable about the longitudinal center axis 6. To this end, the free ends of the flexible tongues 31 each have a detent 32 in this exemplary embodiment.

The first end portion 29 has a smaller outside diameter than the second end portion 30. In this case, the outside diameter of the first end portion 29 is adapted to the inside diameter of the rotational elements 25, 26, 27 and of the rotation stopper 13. In this exemplary embodiment, the outer circumference of the first end portion 29, or an outer side of the flexible tongues 31, bears against the inner circumference of the rotational elements 25, 26, 27 and of the rotation stopper 13.

In the assembled state according to FIG. 2, the first blocking element 11 is fastened to the second end portion 30 of the transmission element 28. In this exemplary embodiment, the outside diameter of the second end portion 30 corresponds to the outside diameter of the first blocking element 11. On account of the fixed connection between the second end portion 30 and the first blocking element 11, the rotation of the steering shaft 5, which is not illustrated in more detail here, or of the entrainment device 16 fastened fixedly to the steering shaft 5, is transmissible via the first blocking element 11 to the transmission element 28 and thus to the rotational device 15.

In order to produce the fixed connection between the second end portion 30 and the first blocking element 11, the second end portion 30 has a plurality of fastening tabs 33 in this exemplary embodiment. For cooperating with the fastening tabs 33, the first blocking element 11 has fastening receptacles 34, formed so as to correspond to the fastening tabs 33, in an outer side of the first blocking element 11. In the assembled state according to FIG. 2, the fastening tabs 33 have been received form-fittingly in the fastening receptacles 34. The fastening tabs 33 and the fastening receptacles 34 are formed regularly in the circumferential direction on the transmission element 28 and the first blocking element 11, respectively. In this exemplary embodiment, the fastening tabs 33 and the fastening receptacles 34 have a trapezoidal shape. For the sake of greater clarity, not all of the fastening tabs 33 and fastening receptacles 34 have been provided with a reference sign.

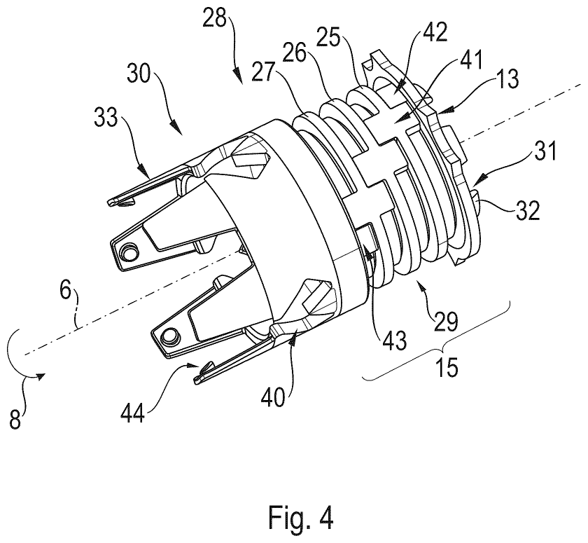

Furthermore, in this exemplary embodiment, the fastening tabs 33 each have, on their inner side, a first latching element 44, which is not identifiable more specifically here (see FIG. 4) and cooperates form-fittingly with a corresponding second latching element 35 of the fastening receptacle 34. According to this example, the first latching element is in the form of a protrusion that extends radially with respect to the longitudinal center axis 6 and the second latching element 35 is in the form of an opening of corresponding shape within the fastening receptacle 34.

Moreover, the end stop device 10 has a spring element 36. The spring element 36 is in the form of a compression spring here and is arranged between the entrainment device 16 and the transmission element 28. In this case, the spring element 36 is supported on the transmission element 28 on one side, specifically on a transition region between the first end portion 29 and the second end portion 30. This transition region, which is formed in a step-like manner here, arises on account of the transition of the first end portion 29, since the first end portion 29 has an outside diameter that is smaller than an inside diameter of the second end portion 30.

On the other side, the spring element 36 is supported on a spring receiving element 37 connected to the entrainment device 16. Here, the spring receiving element 37 is in the form of an independent component. Alternatively, the entrainment device 16 may have a spring receptacle formed integrally therewith. The spring receiving element 37 that is in the form of an independent component here is fixedly connected to the entrainment device 16. In this exemplary embodiment, the spring receiving element 37 has been fitted onto an axial end of the entrainment device 16 in the axial direction with respect to the longitudinal center axis 6 by means of a plurality of insertion slots 38. In this case, ends of the guide ribs 17, 18 that are at the opposite end from the sliding surface 21 engage in the insertion slots 38. For the sake of greater clarity, not all of the insertion slots 38 have been provided with a reference sign.

In the assembled state according to FIG. 2, the spring element 36 counteracts cooperation or moving together of the first blocking element 11 and the further blocking element 12. When the steering shaft 5 is turned back from an end position with a maximum steering angle of rotation, the first blocking element 11 is moved out of the further blocking element 12 in the axial direction with respect to the longitudinal center axis 6. In the assembled state according to FIG. 2, the entrainment device 16 and the spring receiving element 37 are arranged partially within the first blocking element 11 and partially within the transmission element 28 or the second end portion 30.

In this exemplary embodiment, a plurality of portions 39 of the spring receiving element 37, for the one part, and a plurality of portions 40 of the transmission element 28, for the other part, form a return device for reversing the cooperation of the first blocking element 11 and the further blocking element 12. In this case, the return device serves to compensate for a defect or failure of the spring element 36. In the event of a defect or failure of the spring element 36, the return device ensures that, when the steering shaft 5 is turned back from an end position with a maximum steering angle of rotation, the first blocking element 11 is moved out of the further blocking element 12 in the axial direction with respect to the longitudinal center axis 6.

FIG. 4 shows a perspective side view of a part of the end stop device 10 according to FIG. 3. Here, the rotational device 15 having the transmission element 28, the rotational elements 25, 26, 27 and the rotation stopper 13 is shown in an assembled state.

Each rotational element 25, 26, 27 has a stop portion 41 for cooperating with the respectively directly adjacent rotational element 25, 26, 27, or the directly adjacent rotation stopper 13 or the transmission element 28. In this exemplary embodiment, each stop portion 41 is in the form of a two-sided or double-sided protrusion. In this case, the stop portion 41 extends parallel to the longitudinal center axis 6, such that the double-sided protrusion extends from the respective rotational element 25, 26, 27 in two directions that are directed in two axially opposite directions to one another. For the sake of greater clarity, not all of the stop portions 41 have been provided with a reference sign.

The rotation stopper 13 has a stop 42 that extends in the axial direction with respect to the longitudinal center axis 6. In this case, the stop 42 faces the rotational element 25. In a stop mode, illustrated here, of the rotational device 15, the stop portion 41 of the rotational element 25 butts against the stop 42 of the rotation stopper 13, which is fixed in the assembled state according to FIG. 2. As a result, the first rotational element 25 is not rotatable any further in the direction of rotation as per arrow 8 in the assembled state according to FIG. 2.

In the stop mode, illustrated here, of the rotational device 15, the stop portions 41 of the rotational elements 25, 26, 27 each bear on the adjacent stop portion 41 of the respectively directly adjacent rotational element 25, 26, 27.

The transmission element 28, or the first end portion 29, has a further stop 43. The further stop 43 extends in the axial direction with respect to the longitudinal center axis 6. In this case, the further stop 43 faces the rotational element 27. In a stop mode, illustrated here, of the rotational device 15, the further stop 43 butts against the stop portion 41 of the rotational element 27.

Starting from a dead-center position of the steering shaft 5, which is not illustrated in more detail here, it is possible, on account of rotation of the transmission element 28 about the longitudinal center axis 6, for the further stop 43 of the transmission element 28 to butt against the stop portion 41 of the rotational element 27, with the result that this rotational element 27 is set into conjoint rotation with the transmission element 28.

Upon continued rotation in the same direction of rotation, for example as per arrow 8 here, the stop portions 41 of directly adjacent rotational elements 27, 26, 25 successively abut one another, with the result that, ultimately, once the stop portion 41 of the rotational element 25 butts against the stop 42 of the rotation stopper 13, all of the rotational elements 25, 26, 27 and the transmission element 28 are blocked with regard to further rotation in the same direction of rotation.

By means of the rotational device 15, a maximum steering angle of rotation is thus defined. For example, starting from a zero position or dead-center position, a maximum steering angle of rotation of +660° may be defined.

Furthermore, it is readily apparent here that, in the assembled state of the rotational device 15, the flexible tongues 31 engage through both the rotational elements 25, 26, 27 and the rotation stopper 13, and the detents 32 engage behind the rotation stopper 13. As a result, the rotational elements 25, 26, 27, the rotation stopper 13 and the transmission element 28 are held together as seen in the axial direction of the longitudinal center axis 6. This results in a compact cohesive construction.

With regard to the fastening tabs 33, it is apparent here that these each have a first latching element 44 on their inner side. Each first latching element 44 is in the form of a protrusion that is directed inwardly radially with respect to the longitudinal center axis. In the assembled state according to FIG. 2, the first latching element 44 engages in the respectively corresponding second latching element 35 according to FIG. 3.

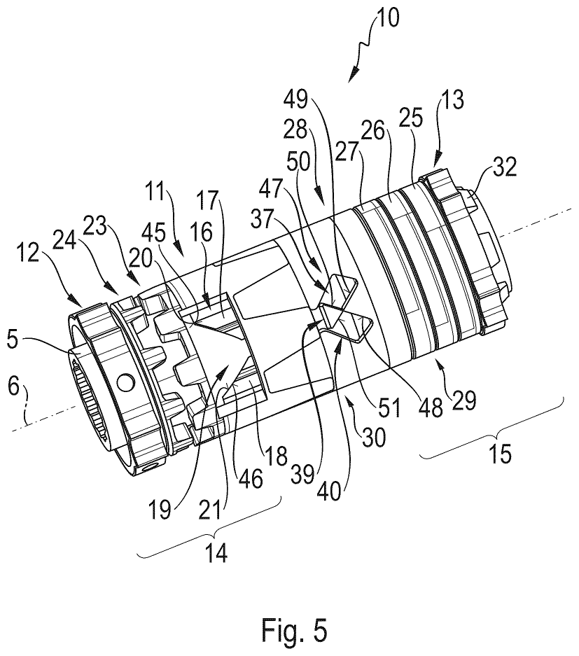

FIG. 5 shows a perspective side view of the end stop device 10 according to FIG. 3 in a rotary mode of the rotational device 15. In this case, for the purposes of clearer illustration, a part of the first blocking element 11 is illustrated in a cutaway manner such that guide ribs 17, 18, located therebeneath, of the entrainment device 16 and a region of the guide slot 19 of the first blocking element 11 are discernible. In addition, a portion of the steering shaft 5 is shown, on which the end stop device 10 is arranged.

First of all, it is apparent that the portions 39, 40 form the return device 47. In this case, the transmission element 28, or the portion 40 thereof, have a first inclined surface 48 and a second inclined surface 49. The spring receiving element 37, or the portion 40, has a first mating inclined surface 50 for cooperating with the first inclined surface 48 and a second mating inclined surface 51 for cooperating with the second inclined surface 49. The two inclined surfaces 48, 49 and the two mating inclined surfaces 50, 51 are each oriented obliquely with respect to the axial extension of the longitudinal center axis 6. In this exemplary embodiment, the two inclined surfaces 48, 49 are oriented in a V shape with respect to one another. According to this example, the two inclined surfaces 48, 49 are constituent parts of a V-shaped slot in the second end portion 30 of the transmission element 28. Furthermore, the two mating inclined surfaces 50, 51 are also oriented in a V shape with respect to one another. According to this exemplary embodiment, the two mating inclined surfaces 50, 51 are constituent parts of a triangular protrusion of the spring receiving element 37. In the rotary mode, in this exemplary embodiment, tips of the portions 39, 40 are oriented so as to be opposite one another.

In the rotary mode of the rotational device 15, when the steering shaft 5 is rotated about the longitudinal center axis 6 by means of the entrainment device 16, the first blocking element 11 is rotatable conjointly with the steering shaft 5 in one of the two directions of rotation about the longitudinal center axis 6 of the steering shaft 5. The rotational device 15 is in the rotary mode when the current steering angle of rotation is between the two defined maximum steering angles of rotation. In this exemplary embodiment, the rotary mode is restricted to a region of the steering angle which extends as far as 20° below the respective maximum steering angle of rotation. If the maximum steering angle of rotation is, for example, 660°, the rotational device is in the rotary mode, according to this example, when the steering angle of rotation is between ±640°. In the rotary mode of the rotational device 15, the sliding surface 21 of the guide rib 17, 18 bears on a portion, facing the further blocking element 12, of a mating sliding surface 46 of the first blocking element 11 or of the guide slot 19. On account of the action of the spring element 36 (not identifiable more specifically here) according to FIG. 3, the sliding surface 21 and the mating sliding surface 46 are pushed together.

In a manner corresponding to the end surface 20 and the sliding surface 21, the mating end surface 45 extends at right angles to the axial extension of the longitudinal center axis 6 and the mating sliding surface 46 extends, from the mating end surface 45, obliquely with respect to the axial extension of the longitudinal center axis 6. At least one free gap is formed between the end surface 20 and the mating end surface 45 in this exemplary embodiment, regardless of the current steering angle of rotation.

The first blocking element 11, the transmission element 28 and the rotational device 15 having the rotational elements 25, 26, 27 and the rotation stopper 13 form a structural unit. This structural unit, on account of cooperating with the entrainment device 16, is rotatable about the longitudinal center axis 6 and/or displaceable in the axial direction of the longitudinal center axis 6. The end stop device 10 and the structural unit are formed in a tubular manner. As a result, the steering shaft 5 can extend through the entire end stop device 10.

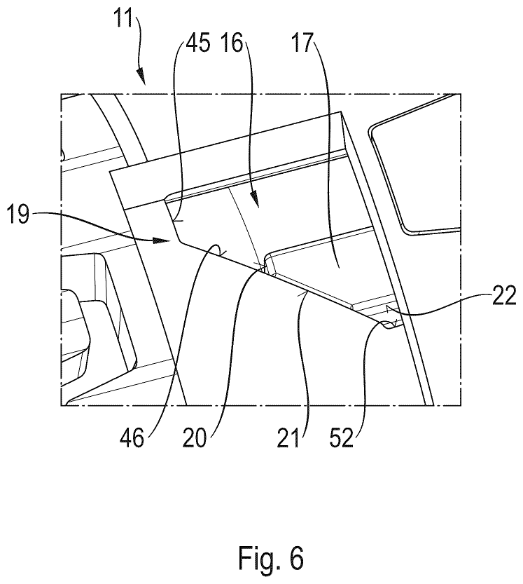

FIG. 6 shows a detail of a perspective side view of the end stop device according to FIG. 3 in a stop mode of the rotational device 15 according to FIG. 4.

It is apparent that the sliding surface 20 of the guide rib 17, 18 is shorter than the mating sliding surface 46 of the first blocking element 11. As a result, the sliding surface 21 and the mating sliding surface 46 can slide on one another depending on the length of the two surfaces. This allows the axial movement of the first blocking element 11, or of the structural unit, for cooperating with the further blocking element 12. In this exemplary embodiment, the rotational device 15 is in the stop mode when the steering angle of rotation is in the range from +640° to +660° or from −640° to −660°.

In the stop mode of the rotational device 15, the latter and thus the structural unit is prevented from rotating further about the longitudinal center axis 6. Upon further rotation of the steering shaft 5 in the same direction of rotation, the first blocking element 11, or the structural unit, is movable only in the axial direction with respect to the longitudinal center axis 6 by means of the entrainment device 16. As a result, the first blocking element 11 can engage in the further blocking element 12. This movement, which is directed only axially with regard to the first blocking element 11, is brought about on account of the sliding movement, illustrated here, of the mating sliding surface 46 of the first blocking element 11 on the sliding surface 21 of the guide rib 17 of the entrainment device 16.

The first blocking element 11, or the guide slot 19, has a mating entrainment surface 52 for cooperating with the entrainment surface 22 of the guide rib 17. In this case, the entrainment surface 22 and the mating entrainment surface 52 are oriented parallel to the longitudinal center axis 6, which is not illustrated in more detail here. At the guide slot 19, the mating sliding surface 46 transitions into the mating entrainment surface 52 in a region at the opposite end from the mating end surface 45.

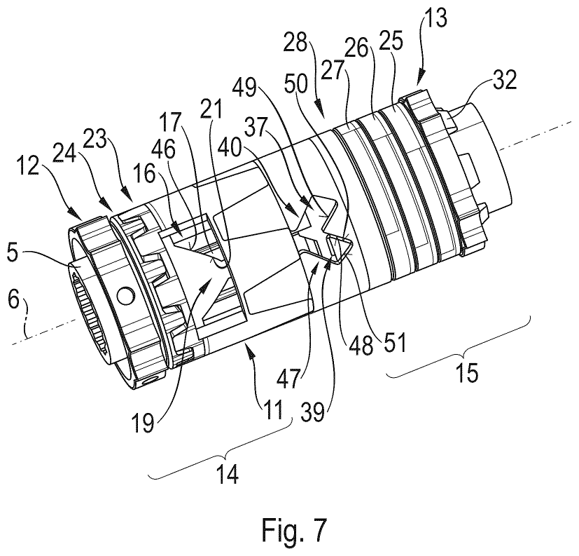

FIG. 7 shows a perspective side view of the end stop device 10, wherein the first blocking element 11 is engaging in the further blocking element 12.

Starting from the states of the end stop device 10 according to FIGS. 5 and 6, the steering shaft has been rotated in the same direction in order to reach the position according to FIG. 7. Since the rotational device 15 is in the stop mode, on account of the further rotation of the entrainment device 16 and the cooperation of sliding surface 21 and mating sliding surface 46, the first blocking element 11 is displaced in the axial direction with respect to the longitudinal center axis 6 until the entrainment surface 22 butts against the mating entrainment surface 52. At the same time, in this exemplary embodiment, teeth of the first toothed structure 23 butt against the further blocking element 12 in tooth gaps of the second toothed structure 24. In a corresponding manner, teeth of the second toothed structure 24 can butt against the first blocking element 11 in tooth gaps of the first toothed structure 23. Alternatively, a free gap may remain between the teeth and the respectively opposite tooth gaps.

In this exemplary embodiment, in the stop mode of the rotational device 15, the teeth of the first toothed structure 23 are oriented centrally opposite tooth gaps of the second toothed structure 24. In a corresponding manner, in the stop mode of the rotational device 15, the teeth of the second toothed structure 24 are oriented centrally opposite tooth gaps of the first toothed structure 23.

In this exemplary embodiment, the teeth of the first toothed structure 23 and of the second toothed structure 24 have different widths. In a corresponding manner, the tooth gaps of the first toothed structure 23 and of the second toothed structure 24 have different widths. As a result, according to this example, the teeth of the two toothed structures 23, 24 continue not to be in contact with one another following the axial movement of the first blocking element 11 and the butting against the further blocking element 12.

With regard to the return device 47, on account of the continued rotation of the steering shaft and thus also of the spring receiving element 37 in combination with the axial displacement of the transmission element 28 connected to the first blocking element 11, the protrusion-like portion 39 has engaged in one groove of the two grooves, formed in a V shape with respect to one another, of the portion 40. In this exemplary embodiment, the inclined surfaces 48, 49 and mating inclined surfaces 50, 51 are designed such that they do not touch in the case of an intact spring element 36. As a result, friction that is unnecessary in normal use is avoided. It is only in the event of a defective or failed spring element 36 that the respective inclined surfaces 48, 49 and the associated mating inclined surfaces 50, 51 come into contact.

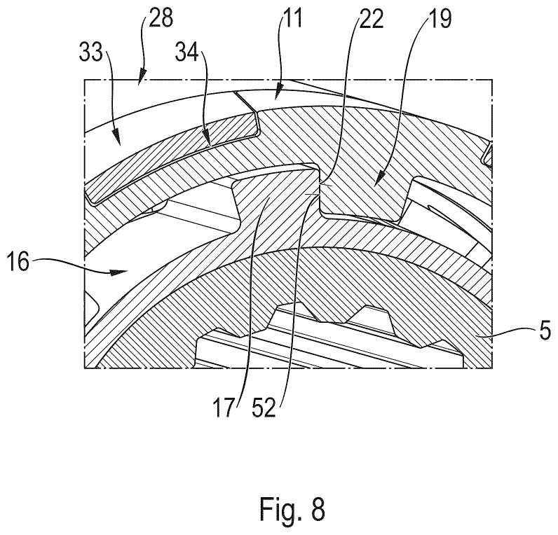

FIG. 8 shows a detail of a perspective cross section through the end stop device 10 according to FIG. 7. It is readily apparent that the entrainment surface 22 is butting against the mating entrainment surface 52. As a result, further axial displacement of the first blocking element 11 in the direction of the further blocking element 12 is prevented upon further rotation of the steering shaft 5 in the same direction of rotation.

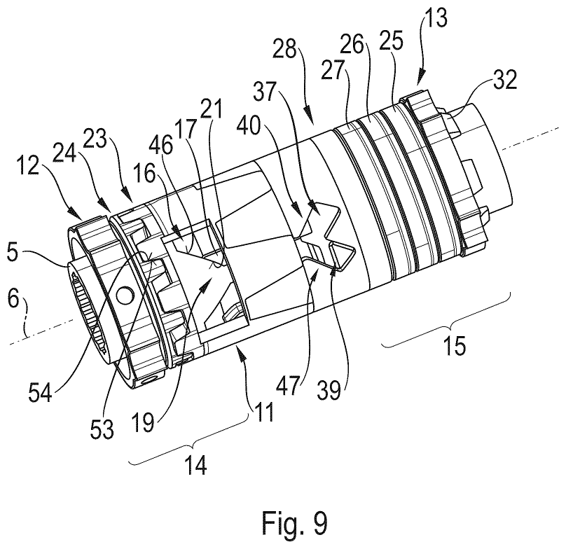

FIG. 9 shows a perspective side view of the end stop device 10 in a stop end position associated with a maximum steering angle of rotation. In this exemplary embodiment, this stop end position is reached starting from the position of the end stop device according to FIGS. 7 and 8 and upon further rotation of the steering shaft 5 in the same direction of rotation.

On account of the entrainment surface 22 bearing against the mating entrainment surface 52 according to FIG. 8, the first blocking element 11 is not displaceable any further in the axial direction of the longitudinal center axis 6. Instead, on account of a defined elasticity and/or tolerances, upon further rotation of the steering shaft 5 and of the entrainment device 16 in the same direction of rotation, only rotation of the first blocking element 11, or of the structural unit, about the longitudinal center axis 6 takes place.

This rotation or rotary movement is limited by a clearance, arising in the circumferential direction, between the axially engaged teeth of the two toothed structures 23, 24. In the stop end position, at least one blocking surface 53 of the first blocking element 11 butts against a mating blocking surface 54 of the further blocking element 12 when a maximum steering angle of rotation is reached. In this case, the blocking surface 53 and the mating blocking surface 54 are oriented parallel or transversely to the axial extension of the longitudinal center axis 6. In this exemplary embodiment, the teeth of the first toothed structure 23 each have a blocking surface 53 on two sides that face away from one another, and the teeth of the second toothed structure 24 each have a blocking surface 54 on two sides that face away from one another.

The above explanations for FIGS. 5 to 9 relate to a rotation in one of the two directions of rotation as per arrows 7, 8 according to FIG. 2. The functionality of the end stop device 10 in the opposite direction of rotation arises analogously thereto.

### REFERENCE SIGNS

1 Steering apparatus
2 Steering column
3 First steering column housing
4 Second steering column housing
5 Steering shaft
6 Longitudinal center axis
7 Arrow
8 Arrow
9 Feedback motor
10 End stop device
11 First blocking element
12 Further blocking element
13 Rotation stopper
14 Blocking device
15 Rotational device
16 Entrainment device
17 Guide rib
18 Guide rib
19 Guide slot
20 End surface
21 Sliding surface
22 Entrainment surface
23 First toothed structure
24 Second toothed structure
25 Rotational element
26 Rotational element
27 Rotational element
28 Transmission element
29 First end portion
30 Second end portion
31 Flexible tongue
32 Detent
33 Fastening tab
34 Fastening receptacle
35 Second latching element
36 Spring element
37 Spring element receptacle
38 Insertion slot
39 Portion
40 Portion
41 Stop portion
42 Stop
43 Further stop
44 First latching element
45 Mating end surface
46 Mating sliding surface
47 Return device
48 First inclined surface
49 Second inclined surface
50 First mating inclined surface
51 Second mating inclined surface
52 Mating entrainment surface
53 Blocking surface
54 Mating blocking surface

1. A steering apparatus having a steering shaft (5) and having an end stop device (10) for limiting a steering angle of rotation, the end stop device (10) having a first blocking element (11), and the first blocking element (11) being movable in an axial direction of the longitudinal center axis (6) of the steering shaft (5) in order to limit the steering angle of rotation, the first blocking element (11) cooperating with a positionally fixed further blocking element (12) in order to stop rotation of the steering shaft (5) about the longitudinal center axis (6) and with regard to two directions of rotation (7, 8) of the steering shaft (5) that are directed in opposite directions to one another, wherein the movement of the first blocking element (11) is guided by means of an entrainment device (16), the entrainment device (16) being connected to the steering shaft (5) in a positionally fixed manner in order to rotate conjointly with the steering shaft (5).

2. The steering apparatus as claimed in claim 1, wherein the first blocking element (11) makes direct contact with the entrainment device (16), and in particular the entrainment part (16) is formed in one part or a plurality of parts.

3. The steering apparatus as claimed in claim 1 or 2, wherein the entrainment device (16) is connected to a rotational device (15), the rotational device (15) having at least one rotational element (25, 26, 27) which is rotatable about the longitudinal center axis (6) of the steering shaft (5) and/or conjointly with the steering shaft (5), and in particular the rotational device (15) has a plurality of annular rotational elements (25, 26, 27) which are arranged in succession in the axial direction of the longitudinal center axis (6), each rotational element (25, 26, 27) having at least one stop portion (41) for cooperating with the respectively adjacent rotational element (25, 26, 27).

4. The steering apparatus as claimed in claim 1, wherein the entrainment device (16) has, distributed about its outer circumference, a plurality of guide ribs (17, 18), the guide ribs (17, 18) extending parallel to the longitudinal center axis (6) of the steering shaft (5), and the guide ribs (17, 18) cooperating with a guide slot (19) in the first blocking element (11), and in particular the guide slot (19) is formed on an inner side of the sleeve-like first blocking element (11).

5. The steering apparatus as claimed in claim 4, wherein the guide ribs (17, 18) each have a sliding surface (21) on an end facing the further blocking element (12), the sliding surface (21) extending obliquely with respect to the axial extension of the longitudinal center axis (6) of the steering shaft (5), in particular the entrainment device (16) has a plurality of pairs of guide ribs (17, 18), the two guide ribs (17, 18) of a respective pair being mirror-symmetric to one another, and preferably the sliding surfaces (21) of the two guide ribs (17, 18) of a respective pair face one another.

6. The steering apparatus as claimed in claim 4 or 5, wherein each guide slot (19) in the first blocking element (11) has a mating sliding surface (46) for cooperating with the sliding surface (21) of the guide rib (17, 18).

7. The steering apparatus as claimed in claim 4, wherein the guide ribs (17, 18) each have an entrainment surface (22) on one side of the guide rib (17, 18), the first blocking element (11) having a mating entrainment surface (52) for cooperating with the entrainment surface (22), and in particular the entrainment surface (22) and the mating entrainment surface (52) are oriented parallel to the axial extension of the longitudinal center axis (6) of the steering shaft (5).

8. The steering apparatus as claimed in claim 2, wherein, in a rotary mode of the rotational device (15), when the steering shaft (5) is rotated about the longitudinal center axis (6) by means of the entrainment device (16), the first blocking element (11) is rotatable conjointly with the steering shaft (5) in one of the two directions of rotation (7, 8) about the longitudinal center axis (6) of the steering shaft (5), and in particular, in the rotary mode of the rotational device (15), a sliding surface (21) of the guide rib (17, 18) bears against a portion, facing the further blocking element (12), of a mating sliding surface (46) of the first blocking element (11).

9. The steering apparatus as claimed in claim 8, wherein the rotational device (15), after passing from the rotary mode into a stop mode of the rotational device (15), is prevented from rotating further about the longitudinal center axis (6) of the steering shaft (5), the first blocking element (11), in the stop mode of the rotational device (15), being movable by means of the entrainment device (16) and, upon further rotation of the steering shaft (5) in the same direction of rotation (7, 8), only in the axial direction with respect to the longitudinal center axis (6), with the result that the first blocking element (11) engages in the further blocking element (12), and in particular the axially directed movement of the first blocking element (11) is brought about on account of a sliding movement of a mating sliding surface (46) of the first blocking element (11) on a sliding surface (21) of the entrainment device (16).

10. The steering apparatus as claimed in claim 7, wherein at least one mating entrainment surface (52) of the first blocking element (11), when a maximum axially extended position of the first blocking element (11) is reached, butts against at least one entrainment surface (22) of the entrainment device (16) and, upon further rotation of the steering shaft (5) in the same direction of rotation, the first blocking element (11) is rotatable conjointly with the entrainment device (16) only about the longitudinal center axis (6) of the steering shaft (5), preferably at least one blocking surface (53) of the first blocking element (11), when a maximum steering angle of rotation is reached, butts against at least one mating blocking surface (54) of the further blocking element (12), and in particular the blocking surface (53) and the mating blocking surface (54) are oriented parallel or obliquely with respect to the axial extension of the longitudinal center axis (6) of the steering shaft (5).

11. The steering apparatus as claimed in claim 2, wherein the rotational device (15) has a rotation stopper (13) which limits rotation of the at least one rotational element (25, 26, 27) both in the first direction of rotation (7) and in the second direction of rotation (8), in particular the rotation stopper (13) is held in a rotationally fixed manner and/or formed in an annular manner, and preferably the rotation stopper (13) is mounted so as to be displaceable in the axial direction with respect to the longitudinal center axis (6).

12. The steering apparatus as claimed in claim 2, wherein a transmission element (28) is arranged between the first blocking element (11) and the rotational device (15) and/or the at least one rotational element (25, 26, 27), the transmission element (28) having a first end portion (29) and a second end portion (30) at the opposite end from the first end portion (29), preferably the at least one rotational element (25, 26, 27) is arranged at the first end portion (29) and the first blocking element (11) is fastened to the second end portion (30), and in particular, on account of the fixed connection between the second end portion (30) and the first blocking element (11), the rotation of the steering shaft (5) is transmissible to the transmission element (28) via the first blocking element (11) and to the rotational device (15) and/or the at least one rotational element (25, 26, 27) via the transmission element (28).

13. The steering apparatus as claimed in claim 12, wherein a spring element (36), in particular a compression spring, is arranged between the entrainment device (16) and the transmission element (28), the spring element (36) being supported on the transmission element (28) on one side and directly on the entrainment device (16) or on a spring receiving element (37) connected to the entrainment device (16) on the other side, and in particular the spring element (36) counteracts cooperation of the first blocking element (11) with the further blocking element (12).

14. The steering apparatus as claimed in either of the preceding claim 12, wherein the first blocking element (11), the transmission element (28) and the rotational device (15) form a structural unit, this structural unit, on account of cooperating with the entrainment device (16), being rotatable about the longitudinal center axis (6) of the steering shaft (5) and/or being displaceable in the axial direction of the longitudinal center axis (6) of the steering shaft (5), and in particular the end stop device (10) and/or the structural unit is/are formed in a tubular manner.

15. The steering apparatus as claimed in claim 1, wherein at least one portion (39) of the entrainment device (16) or of a spring receiving element (37), for the one part, and at least one portion (40) of the transmission element (28), for the other part, form a return device (47) for reversing cooperation of the first blocking element (11) and the further blocking element (12), in particular the transmission element (28) has a first inclined surface (48) and a second inclined surface (49), the entrainment device (16) or the spring receiving element (37) having a first mating inclined surface (50) for cooperating with the first inclined surface (48) and a second mating inclined surface (51) for cooperating with the second inclined surface (49), and in particular the two inclined surfaces (48, 49) and the two mating inclined surfaces (50, 51) are oriented obliquely with respect to the axial extension of the longitudinal center axis (6).

16. The steering apparatus as claimed in claim 1, wherein the steering shaft (5) extends through the end stop device (10), a first end of the steering shaft (5) being designed for the arrangement of a steering handle and/or the end stop device (10) being arranged within an, in particular telescopic, steering column (2), and preferably the tubular end stop device (10) is arranged between the steering shaft (5) and a tubular steering column housing (3).

17. A steer-by-wire steering system having a steering apparatus (1) as claimed in claim 1.
